(19) United States
(12) Patent Application Publication
(10) Pub. No.: US 2011/0220263 A1
(43) Pub. Date: Sep. 15, 2011

(54) Pattern coated cap ply for tire construction

(76) Inventor: Danny F. Michiels, Haaltert (BE)

(21) Appl. No.: 12/661,170

(22) Filed: Mar. 11, 2010

(51) Int. Cl. B60C 9/18

(52) U.S. Cl. 152/526

(57) ABSTRACT

A pneumatic tire has a tread, a carcass with belt plies disposed below the tread, and a cap ply layer between the tread and the belt plies of the carcass. The cap ply is a cap ply tape containing at least one layer of fabric selected from the group consisting of woven, knit, and nonwoven having a first side and a second side, a resorcinol formaldehyde latex (RFL) coating on both the first and second side of the fabric, and a patterned coating of an adhesion promoter on at least a first side of the fabric overlaying a portion of the RFL coating. The tape is wound in a flat helically wound around the belt plies and covered with a tread of the tire.

### BACKGROUND

The present invention generally relates to pneumatic tires, and in particular, to construction of ply tires with belt plies.

Typically, tires are manufactured from a single or multiply carcass of substantially U-shaped section having metal beads at the inner perimeters of the walls. Support can be provided to a tire carcass by steel cord belt plies extending around the outer periphery of the carcass and across the width of the tread. Such steel belt plies are relatively inextensible in the intended direction of rotation of the tire and include steel belt cords disposed parallel to that direction or at a low angle thereto. The belt plies act to restrict the movement of the tread and give the tire better road-holding properties. Support such as this type is particularly important in a radial tire, where the carcass is formed from a rubberized woven fabric having relatively inextensible reinforcing cords running transversely, i.e. radially, from bead to bead.

Technical difficulties have been encountered in incorporating steel belts into the tread area of the tire. One of the difficulties lies in ensuring good adhesion between the steel and the rubber. The centrifugal force of the steel belts can cause difficulty in the adhesion of the belt within the tire. Additionally, movement of the steel belts at higher speeds tends to create excessive temperatures in the tire, which can cause tread failure and delamination. The problem of delamination is particularly noticeable in the shoulder area of the tire.

One solution of the problem previously used by tire manufactures is to use a layer of calendared fabric laid circumferentially over the belt. This calendared fabric can also be used with wide fabric strips placed over the shoulder area of the tire, retaining the edges of the steel belt in a specific location of the tire. An example of this type of tire can be found in U.S. Pat. No. 4,284,117, issued to Poque et al. on 18 Aug. 1981. Another solution was to use a rubber tape formed with cords disposed longitudinally within the tape, and was wound around the belt plies and across the width of the tire. An example of this type of tire can be found in WO 2005/002883, filed by Pirelli Pneumatic S.P.A., and published on 13 Jan. 2005.

These prior art rubberized fabrics were used as cap ply layers to give structural integrity to a tire and have enough “green tack” in order to be able to be used in the current tire manufacturing processes where a cap ply is wrapped around an uninflated carcass.

It is desirable to reduce the amount of rubber in the tire and between the cap ply layers as the excess rubber absorbs energy from the running tire and causes early wear and failure. Thus there is a need for a cap ply material to protect a tire from wear during use have enough green tack for manufacture, while at the same time minimizing the amount of rubber or other adhesion promoting compounds on the cap ply fabric.

### BRIEF DESCRIPTION OF THE FIGURES

An embodiment of the present invention will now be described by way of example, with reference to the accompanying drawings.

FIG. 1A is a cutaway partial view of a pneumatic radial tire illustrating one embodiment of the invention with one cap ply strip wrapped around the carcass.

FIG. 1B is a cutaway partial view of a pneumatic radial tire illustrating one embodiment of the invention with two cap ply strips wrapped around the carcass.

FIG. 1C is a cutaway partial view of a pneumatic radial tire illustrating one embodiment of the invention where the cap ply is wrapped helically.

FIG. 2 is a cross-sectional view corresponding to FIG. 1a;

FIG. 3 is a schematic of a top view of the cap ply having a discontinuous dot pattern of an adhesion promoter on surface of the fabric.

FIG. 4 is a schematic of a top view of the cap ply having a discontinuous pattern of random areas of an adhesion promoter on surface of the fabric.

FIG. 5 is a schematic of a top view of the cap ply having a grid pattern of an adhesion promoter on surface of the fabric.

FIG. 6 a schematic of a top view of the cap ply having pattern of a series of parallel lines of an adhesion promoter on surface of the fabric.

FIG. 7A is a schematic of a side view of a cap ply showing the discontinuous pattern of the adhesion promoting chemistry on one side of the fabric.

FIG. 7B is a schematic of a side view of a cap ply showing the discontinuous pattern of the adhesion promoting chemistry on both sides of the fabric.

FIG. 8 is a schematic of a top view of the cap ply having pattern of a dots of varying density across the fabric.

### DETAILED DESCRIPTION

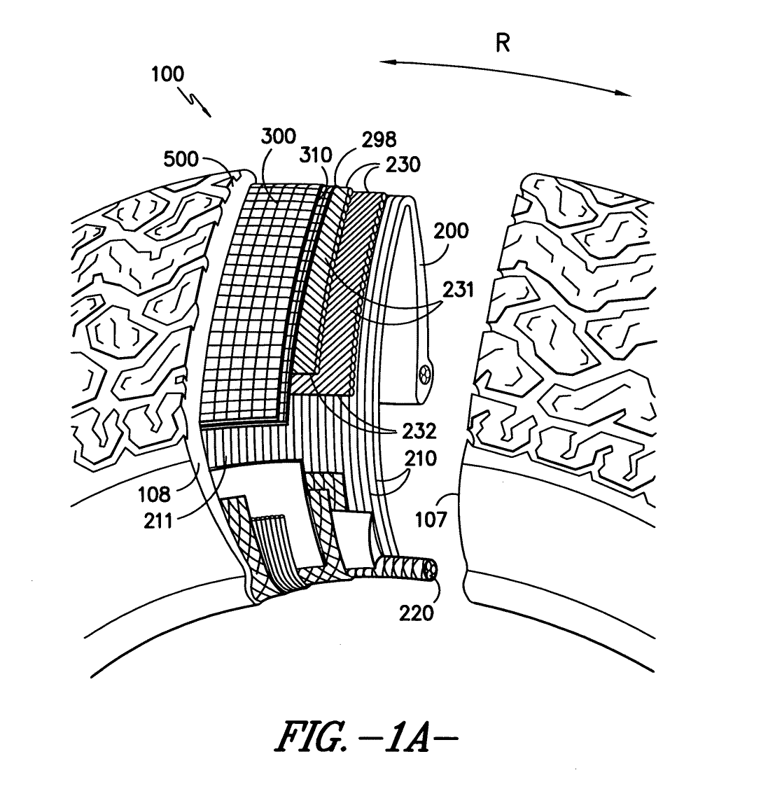

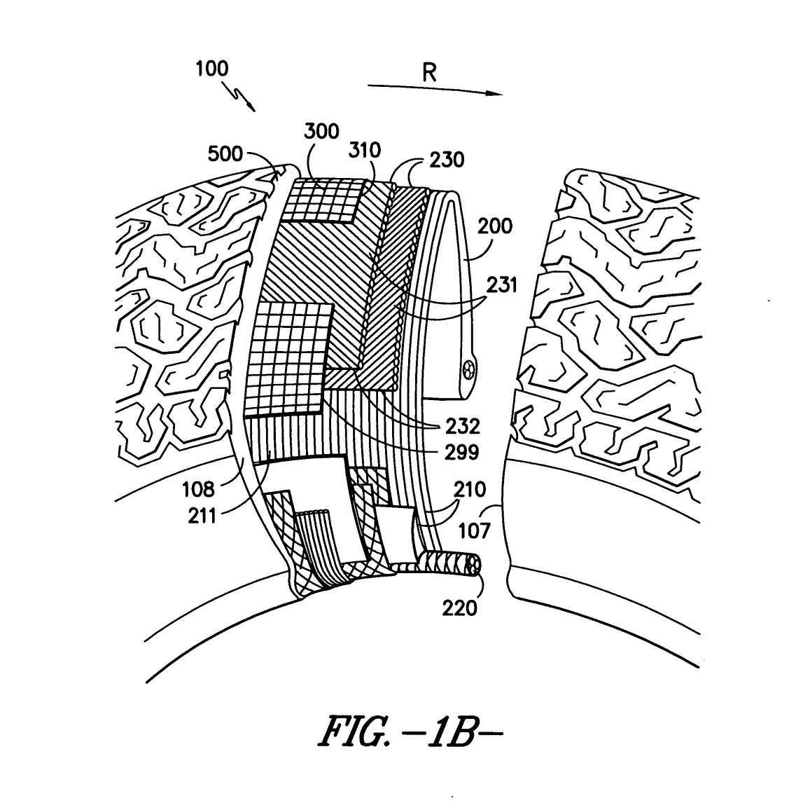

Referring now to the drawings, particular to FIGS. 1A-1C, there is shown a tire 100, comprising side walls 107 joined to a tread 500 by shoulders 108. The tire 100 includes a carcass 200 covered by the tread 500. In FIGS. 1A-1C and 2, the tire 100 is a radial tire. However, the present invention is not limited to radial tires and can also be used with other tire constructions. The carcass 200 is formed from one or more plies of tire cord 210 terminating at the inner periphery of the tire in metal beads 220, with at least one belt ply 230 located circumferentially around the tire cord 210 in the area of the tread 500. In the tire shown in FIGS. 1A-C, the carcass 200 is constructed so that the reinforcing cords 211 are running substantially radially of the intended direction of rotation R of the tire 100. The belt plies 230 are formed with relatively inextensible warp materials 231, such as steel cord reinforcing warps, which run in the intended direction of rotation R of the tire or, more usually, at a slight angle thereto. The angle of the inextensible warp materials 231 can vary with the method of construction or application. The belt plies 230 extend across the width of the tread 500 of the tire terminating in edges 232 in the area of the shoulder 108 of the tire 100, i.e. the area where the tread 500 meets the side wall 107.

In the present invention, a cap ply layer 300 (in FIGS. 1A-C) is located between the belt plies 230 and the tread 500. In FIG. 1A, the cap ply layer 300 is formed from a cap ply tape 310 wound around the tire cord 210 in the rolling direction of the tire. In the embodiment illustrated in FIG. 1A, the cap ply tape 310 extends over the edges 232 of the belt plies 230. Additionally, the cap ply tape 310 in FIG. 1A can be wound around the tire cord 210 a plurality of times to reduce the unbalancing effect in the tire 100 caused by the overlap splice. FIG. 1B, the cap ply layer 300 is formed from a cap ply tape 310 which extends over the edge 232 of the belt plies 230. The cap ply layer 300 in FIG. 1C is formed from a cap ply tape 310 which is wound circumferentially around the carcass 200 of the tire 100 in a flat helical pattern. The cap ply tapes 310 in each of the FIGS. 1A-C are made of the same fabric. The width of the cap ply tapes 310 and how it is wrapped varies between the FIGS. 1A-C. FIG. 2 illustrates another view of the tire of FIG. 1C. The cap ply layer may also be any open fabric that helps a tread compound bond with a belt compound.

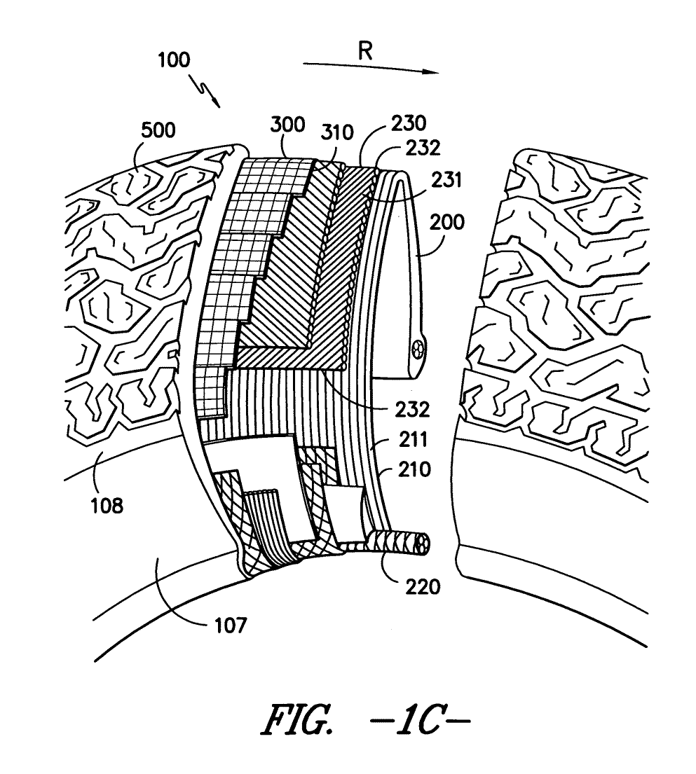

Referring now to FIG. 3, there is shown one embodiment for the cap ply tape 310. The cap ply tape 310 comprises a fabric base 323, a resorcinol formaldehyde latex (RFL) coating 325 on both the first and second sides of the fabric base 323, and a patterned coating of an adhesion promoter 327 on at least one side of the side overlaying the RFL coating 325.

The fabric base 323 of the cap ply tape may be any suitable fabric for use in a cap ply 300. The fabric base 323 may be a woven, nonwoven, knit, or unidirectional construction. In one embodiment, the fabric base 323 is a leno woven fabric. The base fabric may also be, for example, satin, twill, basket-weave, poplin, jacquard, and crepe weave textiles. Knit textiles for use as the fabric base 323 can include, but are not limited to, circular knit, reverse plaited circular knit, double knit, single jersey knit, two-end fleece knit, three-end fleece knit, terry knit or double loop knit, weft inserted warp knit, warp knit, and warp knit with or without a microdenier face. In one embodiment, the stitching yarns of the knit textile may form stitches along a single warp yarn or may move to adjacent warp yarns as shown in US Patent Application Publication 2007/0181238 by Ternon et al., herein incorporated by reference.

In one embodiment, the fabric base 323 is a plain weave fabric which is also typically used as tire cord in a different area of the tire construction. This plain weave fabric is typically made of nylon yarns in the warp and weft directions, though other yarns may be used. In one specific example, the yarns used are nylon 6,6 with a 940 detex and 1 ply. Any desired construction may be used, with one embodiment having with between 100 and 150 ends per decimeter and about 10-15 warps per decimeter. The yarns may have any level of twisting, which in one embodiment preferably is about 110 twists per meter. The fabric may be cut to any desired width, which in one application is approximately 10 mm.

In the embodiments where the fabric base 323 is a knit or woven, the construction can have from 2 up to 28 ends per inch (0.7 to 11 ends per centimeter). Number of ends is defined as the number of wales or the number of needles (or gauge) on a fabric or the number of warp yarns 312 per cm (or per inch). In one embodiment, there are between 2 and 40 stitches (of the stitching yarn 311) per inch (0.8 and 16 stitches per cm).

The term non-woven refers to structures incorporating a mass of yarns that are entangled and/or heat fused so as to provide a coordinated structure with a degree of internal coherency. Non-woven fabrics for use as the fabric bases 323 may be formed from many processes such as for example, meltspun processes, hydroentangeling processes, mechanically entangled processes and the like. A unidirectional textile for use as the fabric base 323 may have overlapping yarns or there may be gaps between the yarns.

The “warp” yarns (warp yarns in woven and knit, unidirectional yarns, and longitudinally oriented in the non-woven) extend longitudinally along the cap ply tape 310, which also wrap around the carcass 200 due to the wrapping of the cap ply tape 310 around the carcass 200. It is the warp yarns in the base fabric 323 that provide most of the reinforcement of the cap ply layer 300. The construction, material, size, and spacing of all of the yarns are selected such that they provide the desired strength of the cap ply layer 300 to prevent the belt ply 230 from moving outward in the tire 100 and to protect the rubber in the tire 100 from sharp portions of the belt plies 230.

The yarns of the base fabric 232 can be a spun staple yarn, a multifilament yarn, and/or a monofilament yarn and are formed of a material which will restrain the belt plies 230. “Yarn”, in this application, as used herein includes a monofilament elongated body, a multifilament elongated body, ribbon, strip, fiber, tape, and the like. The term yarn includes a plurality of any one or combination of the above. Some suitable materials for the yarns include polyamide, aramides (including meta and para forms), rayon, PVA (polyvinyl alcohol), polyester, polyolefin, polyvinyl, nylon (including nylon 6, nylon 6,6, and nylon 4,6), polyethylene naphthalate (PEN), cotton, steel, carbon, fiberglass, steel, polyacrylic or other known artificial or natural fibers. In one embodiment, the yarns may be single monofilament or multifilaments yarns (twisted and/or cabled cords) made with any of the prior listed materials, also including hybrid yarns, or film-tape yarns. In one embodiment, the yarns used in the “warp direction” should be between 100 decitex (90 deniers) up to 23,500 decitex (21,000 deniers) made with single or multiple yarns (for example, 235 decitex (single end) or 235 decitex×2×3 plies equals 1,410 decitex or 1,100 decitex×3×3 plies equal to 9,900 decitex (multiple ends)). In one embodiment, the yarns used in the fabric base 323 may be hybrid yarns. These hybrid yarns are made up of at least 2 fibers of different fiber material (for example, cotton and nylon). These different fiber materials can produce hybrid yarns with different chemical and physical properties. Hybrid yarns are able to change the physical properties of the final product they are used in. Some preferred hybrid yarns include an aramide fiber with a nylon fiber, an aramide fiber with a rayon fiber, and an aramide fiber with a polyester fiber.

A frequent problem in making a rubber composite is maintaining good adhesion between the rubber and the reinforcement. A conventional method in promoting the adhesion between the rubber and the reinforcement is to pretreat the reinforcing yarn with a mixture of rubber latex and a phenol-formaldehyde condensation product wherein the phenol is almost always resorcinol. This is the so called “RFL” (resorcinol-formaldehyde-latex) method.

The base fabric 323 is coated with the resorcinol formaldehyde latex coating 325 by a conventional method. Generally, the RFL coating 325 is applied by dipping the fabric or yarns in a RFL solution. The coated fabric or yarns then pass through squeeze rolls and a drier to remove excess liquid. The RFL coating 325 usually is cured at a temperature in the range of 150° to 200° C. The resorcinol-formaldehyde latex can contain vinyl pyridine latexes, styrene butadiene latexes, waxes, fillers and other additives. The RFL coating 325 is typically on both sides of the base fabric 323.

The cap ply tape 310 has a patterned coating 327 of an adhesion promoter on at least one side located on top of the RLF coating 325. The patterned coating may be on one or both sides of the cap ply fabric over the RFL coating. The two sides may have the same pattern or different patterns. In one embodiment, the adhesion promoter is placed on one side of the cap ply fabric in a patterned coating and on the other side, the adhesion promoter may be placed as a continuous non-patterned coating. Typical examples of adhesion promoters include mixtures containing resorcinol formaldehyde latex (RFL), isocyanate based material, epoxy based material, rubber, PVC, and materials based on melamine formaldehyde resin. This patterned coating 327 is designed to have a tackified finish applied for facilitating adhesion, or green tack, during the building process of the green tire. The selection of materials for the tackified finish will depend greatly upon the materials selected for use in the tire, and the skilled person on the basis of his common knowledge can easily determine them appropriately. In prior art, the entire cap ply tape surface was completely covered in a cement coating of rubber or with a different adhesion promoting chemistry. It is desirable to reduce the amount of rubber in the tire and between the layers as the excess rubber absorbs energy from the running tire and causes early wear and failure.

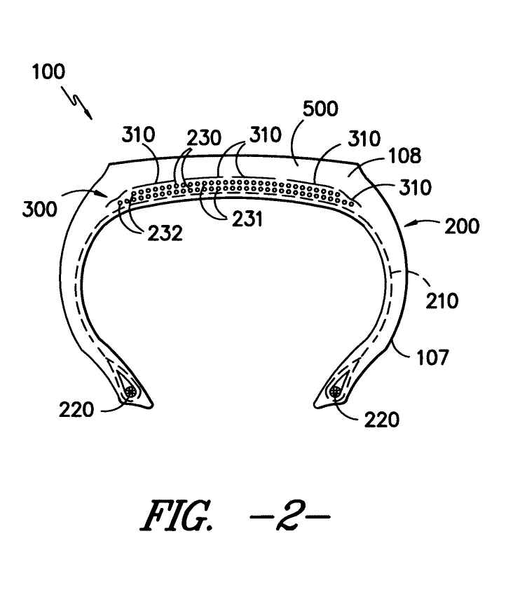

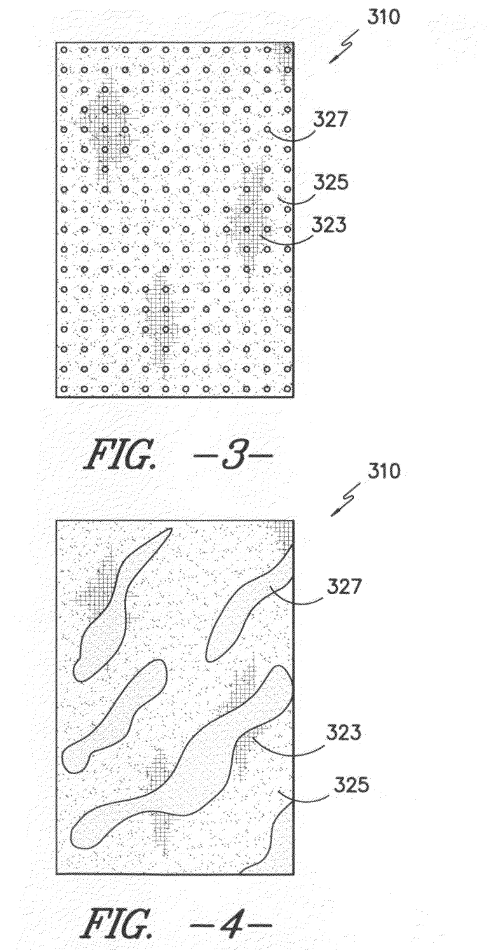

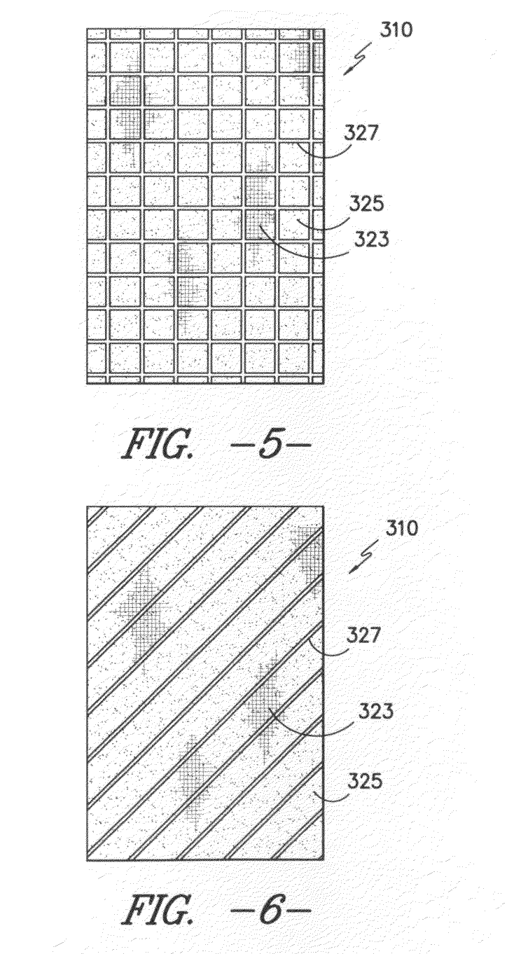

The patterned coating 327 provides for greentack while minimizing the amount of the RFL coating that is covered up and minimizes the amount of rubber or other adhesion promoters in the tire. The patterned coating 327 may be continuous or discontinuous, regular and repeating or random. “Continuous” in this application means that from one edge of the fabric to the other edge there is a path that contains the patterned coating and that at least some of the patterned coating areas are connected. Examples of continuous coatings include FIGS. 5 and 6. “Discontinuous” in this application means that the patterned coated areas are discontinuous and not touching one another. In a discontinuous patterned coating, there is no path from one edge of the fabric to the other that contains the patterned coating. Examples of discontinuous coatings include FIGS. 3 and 4. Regular or repeating patterns mean that the pattern has a repeating structure to it. FIGS. 3, 5 and 6 illustrate repeating or regular patterns. FIG. 4 illustrates a random pattern where there is no repeat to the patterned coating. In a random pattern, it is preferred that the random pattern is also discontinuous, not continuous.

FIG. 3 illustrates the embodiment where the patterned coating is in a dot pattern. This pattern is discontinuous and repeating. The dots may be equally spaced on the fabric, or may have differing densities of dots or sizing of dots across the surface of the fabric. FIG. 4 illustrates the embodiment where the patterned coating 327 is in random, discontinuous spotting pattern. FIG. 5 illustrates the embodiment where the patterned coating 327 is in a grid. This pattern is regular and continuous. FIG. 6 illustrates the embodiment where the patterned coating 327 is in a series of parallel lines. This pattern is also regular and continuous. The patterned coating 327 may take any other patterned form including but not limited to indicia, geometric shapes or patterns, and text.

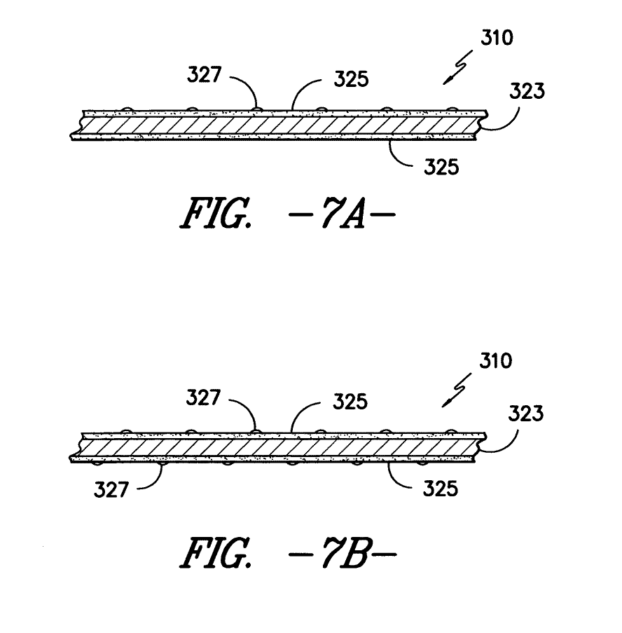

FIGS. 7A and 7B illustrate side views of the cap ply tape 310 illustrating the patterned coating 327 on one side of the cap ply tape 310 (7A) and both sides of the cap ply tape 310 (7B). The patterned coatings may be the same or different patterns and coverage on both sides of the cap ply. For example, one side of the cap ply may have a regular repeating grid pattern covering 10% of the surface area and the other side of the cap ply may have a discontinuous repeating dot pattern covering 25% of the surface. Each surface pattern may be chosen to optimize the tire production process and article.

In one embodiment, the patterned coating 327 of adhesion promoter is on the cross-over points in the fabric, for example where the weft and warp yarns cross in a woven fabric. In another embodiment, the patterned coating 327 of adhesion promoter is substantially only on the cross-over points in the fabric and not on the rest of the fabric base 323.

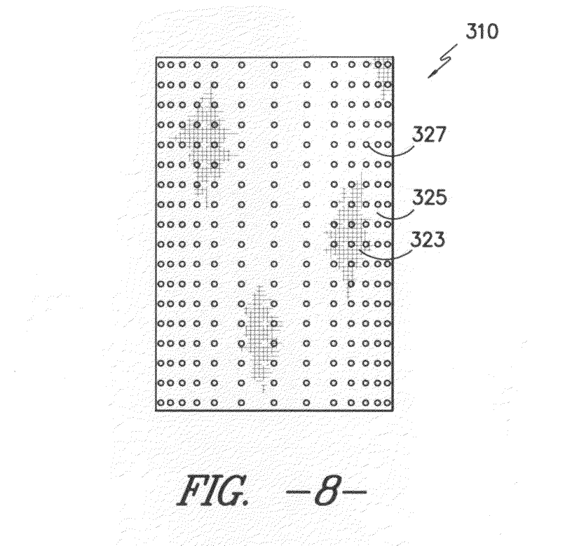

The patterned coating 327 may be formed by any known method of forming a patterned coating including but not limited to inkjet printing, gravure printing, patterned printing, thermal transfer, spray coating, and silk printing. The thickness and/or physical composition of the patterned coating 327 may vary over the length and/or width of the cap ply tape 310. For example, it may be preferred in some embodiments to have a thicker coating or more densely packed pattern in some areas of the cap ply. This can be seen, for example, in FIG. 8 where the dot pattern of the patterned coating layer varies over the width of the cap ply to have a higher amount of patterned coating on the edges of the cap ply.

In one embodiment, the patterned coating covers between about 5 and 95% of the surface area of the cap ply tape 310. In other embodiments, the patterned coating may cover between about 5 and 70%, 10 and 60%, 45 and 75%, greater than 15%, greater than 20% and greater than 30% of the surface area of the cap ply tape 310. In another embodiment, the patterned coating 327 has a weight of between about 5 and 60% wt of the cap ply tape 310. In other embodiments, the patterned coating has a weight of between about 5 and 50%, 10 and 50%, 10 and 45%, 15 and 35%, greater than 15%, greater than 20% and greater than 30% of the weight of the cap ply tape 310.

In the embodiment shown in FIG. 1A, the cap ply tape 310 is located edge to edge as it is laid on the carcass 200 of the tire 100, and is wrapped around the entire belt ply 230 area of the tire 100. In the embodiment shown in FIG. 1B, two pieces of the cap ply tape 310 are wrapped around the carcass 200 of the tire 100 such that the cap ply layer 300 extends beyond the edges 232 of the belt plies 230, under the shoulder 108 area of the tire 100. Overlapping the edge 232 of the belt 230 with the cap ply tape 310 provides support to the edges 232 of the belt 230 where excessive temperature can build up.

For the embodiment shown in FIG. 1C, the cap ply tape 310 is constructed with a width preferably of about 5 mm to 25 mm. More preferably, the cap ply tape 310 is constructed with a width of about 8 mm to 15 mm. The width of the cap ply tape 310 affects the ability to form a uniform flat layer of the cap ply tape 310 across the surface of the carcass 200 of the tire 100. In the helical wrapping process, wider strips will cause buckles on the leading edge of the wrap due to excessive width of the materials. Shorter widths provide difficulties in manufacturing the tire 100 due to an excessive number of revolutions necessary in the wrapping procedure to achieve the desired coverage of the carcass 200 with the cap ply tape 310.

Also in the embodiment shown in FIG. 1C, the cap ply tape 310 permits the strike through of the rubber in the tire 100 for a better bonded construction. The flat helical pattern typically will need more than three full revolutions of the cap ply tape 310 around the carcass 200 of the tire 100. The length of cap ply tape 310 will depend on the diameter of the tire 100, the width of the cap ply tape 310, and the amount of coverage provided by the cap ply tape 310. The approximate minimum length of a cap ply tape 310 in a cap ply layer 300, with only one layer of cap ply tape 310 and no gaps or over lapping regions, can be calculated according to the following formula:

length=2Ørw/t

where Ø is 3.14, r is the radius of the tire, w is the width of the area of the tire to be covered, and t is the width of the tape. As an example, for a 185/60/R14 tire, the length of a 13 mm wide cap ply tape 310 would be a minimum of about 15 linear meters in length, and can have an additional amount of about 2-3 meters for overlapping itself in the shoulder area. Greater strength can be built into the cap ply tape 310 by constructing the cap ply tape 310 such that the warp yarns in the cap ply tape 310, run longitudinally for the length of tape as continuous uncut yarns. Cross-winding the cap ply tape 310 across a cardboard tube provides a convenient package for subsequent removal of the cap ply tape 310 in the manufacturing process of tire 100.

The cap ply layer 300, shown in FIGS. 1A-C, can comprises multiple layers, e.g. two, three, or even more layers, of the cap ply tape 310 that are wound over the ply layer 230 of the carcass 200 to provide extra strength. In one embodiment, the cap ply tape 310 is laid into a double layer in the shoulder 108 area of the tire 100, providing additional strength at the edges 232 of the belt 230. In another embodiment, the cap ply layer 300 can have two layers of cap ply tape 310 securing the belt ply 230 across the width of the tire 100. When more than one layer of cap ply tape 310 is used for the cap ply 300, a layer of unvulcanized rubber is placed between the layers of cap ply tape 310 to insure a good bond. Also, in an embodiment where multiple layers of the cap ply tape 310 are used, the layers of cap ply tape 310 can be staggered so that upper strips of cap ply tape 310 cover the edges of the cap ply tape 310 in the lower layer.

The cap ply layer 300 of the present invention can be used with one belt ply, two belt plies (as illustrated in FIGS. 1A-1C and 2), or more than two belt plies below the cap ply layer 300. In an alternate embodiment of the present invention the tire can have multiple belt plies with cap ply layers, disposed over each belt ply layer creating alternating layers of belt plies and cap plies. In the alternate embodiment, the cap ply layer can also overlap the edge of the underlying belt ply, and/or have multiple layers of cap ply tape (which can also be staggered so that upper strips overlap edges on lower strips).

The formation of the cap ply tape 310 begins with the acquisition of the basic yarns for the fabric. Subsequently, the yarns may be twisted to provide additional mechanical resilience. After the twisting, the fabric is formed in large widths, such as 61.4 inches. After the fabric formation, the fabric is finished with an RFL coating before or after slitting. The adhesion promoter may also be applied to the yarns before forming into a fabric. Next, a patterned coating is applied to the fabric base 323. In another embodiment, the yarns are RFL treated and then treated with an adhesion promoter in a discontinuous manner before the fabric base is formed. The final fabric is slit into the specific cap ply tape 310 widths for placement on a spool.

In the tire formation process, the tire carcass 200 is formed with the tire cord 210, metal beads 220, and belt plies 230. After the tire carcass 200 is formed (and is tire shaped), the cap ply tape 310 is wound from the package around the belt plies 230 to form the cap ply layer 300. After the cap ply layer 300 is placed on the tire carcass 200, the tread 500 is molded onto the subassembly, and the tire 100 is completed. Alternatively, the cap ply tape 310 may be wrapped into the diameter of the finished tire and may or may not have additional layers applied to it, such as tread. Then the tire is formed from a flat shape expanded and shaped into a tire shape to meet up with the ring of fabric tape and the two are joined together.

What is claimed is:

1. A pneumatic tire comprising:
a tread;
a carcass having at least one belt ply disposed below the tread; and,
a cap ply located between the carcass and the tread wherein the cap ply is disposed around the circumference of the carcass in the area of the belt ply, and, wherein the cap ply comprises a cap ply tape comprising:
at least one layer of fabric selected from the group consisting of woven, knit, and nonwoven having a first side and a second side;
a resorcinol formaldehyde latex (RFL) coating on both the first and second side of the fabric; and,
a patterned coating of an adhesion promoter on at least a first side of the fabric overlaying a portion of the RFL coating.

2. The pneumatic tire of claim 1, wherein the patterned coating is discontinuous.

3. The pneumatic tire of claim 1, wherein the patterned coating is continuous.

4. The pneumatic tire of claim 1, wherein the patterned coating is repeating.

5. The pneumatic tire of claim 1, wherein the patterned coating is random.

6. The pneumatic tire of claim 1, wherein the patterned coating comprises coated lines.

7. The pneumatic tire of claim 1, wherein the patterned coating comprises a coated grid of lines.

8. The pneumatic tire of claim 1, wherein the patterned coating comprises discontinuous coated dots.

9. The pneumatic tire of claim 1, wherein the patterned coating covers between about 45 and 75% of the first side of the fabric.

10. The pneumatic tire of claim 1, wherein the patterned coating has a weight of between about 15 and 45% of the weight of the fabric.

11. The pneumatic tire of claim 1, wherein the patterned coating covers a portion of both of the sides of the fabric.

12. The pneumatic tire of claim 1, wherein the patterned coating comprises coated indicia.

13. The pneumatic tire of claim 1, wherein the adhesion promoter is selected from the group consisting of resorcinol formaldehyde latex (RFL), isocyanate based material, epoxy based material, melamine formaldehyde resin, and natural or synthetic rubber.

14. The pneumatic tire of claim 1, wherein the cap ply is disposed in a flat helical pattern around the circumference of the carcass in the area of the belt ply.

15. The pneumatic tire of claim 1, wherein the cap ply has two or more layers of the pattern coated fabric.

16. The pneumatic tire of claim 15, wherein the tire includes a layer of rubber between the layers of the pattern coated fabric.

17. The pneumatic tire of claim 1, wherein the tire further includes a second belt ply placed over the cap ply and a second cap ply layer over the second belt ply and below the tire tread.

18. The pneumatic tire of claim 1, wherein the fabric comprises hybrid yarns.

19. The pneumatic tire of claim 1, wherein the cap ply has a width in a range of from about 5 mm to about 25 mm.

20. The pneumatic tire of claim 1, wherein the pattern coated fabric makes more than three full revolutions around the circumference of the tire carcass.
